(19) United States
(12) Patent Application Publication
(10) Pub. No.: US 2025/0042190 A1
(43) Pub. Date: Feb. 6, 2025

(54) PRINTING APPARATUS AND METHOD OF CONTROLLING PRINTING APPARATUS

(71) Applicant: SEIKO EPSON CORPORATION, Tokyo (JP)

(72) Inventors: Keita HANAWA, MATSUMOTO-SHI (JP); Kazunori TAKABAYASHI, OKAYA-SHI (JP)

(21) Appl. No.: 18/791,614

(22) Filed: Aug. 1, 2024

(30) Foreign Application Priority Data
Aug. 4, 2023 (JP) 2023-127793

(51) Int. Cl. B41J 25/304; B41J 2/165; B41J 3/407; B41J 11/06; B41J 11/14; B41J 29/46

(52) U.S. Cl. CPC B41J 25/304; B41J 2/16517; B41J 3/4078; B41J 11/06; B41J 11/14; B41J 29/46

(57) ABSTRACT

A printing apparatus includes: an attachment unit configured to enable a medium support portion to be attached and detached, the medium support portion including a support face; a head; a first movement unit configured to move the head; a second movement unit configured to move the head; a control unit configured to control the first movement unit and the second movement unit; an input unit; and a notification unit. The head is configured to move to an opposed region in which the head is opposed to the support face. When a movement instruction is inputted into the input unit, the notification unit gives notification that prompts the user to detach the medium support portion, and the control unit causes the head to move from a standby position to a cleaning position, a portion of or whole of the cleaning position being included in the opposed region.

The present application is based on, and claims priority from JP Application Serial Number 2023-127793, filed on Aug. 4, 2023, the disclosure of which is hereby incorporated by reference herein in its entirety.

### BACKGROUND

### 1. Technical Field

The present disclosure relates to a printing apparatus and a method of controlling a printing apparatus.

### 2. Related Art

For example, as in JP-A-2008-162174, there is disclosed a printing apparatus configured to move a head along a first direction to perform printing on a medium. The head is configured to be able to move, in the first direction, to a printing region and a non-printing region. A maintenance region is allocated to the non-printing region. Such a print apparatus includes a mirror with the aim of visually recognizing a nozzle surface of the head from the outside when the head is disposed in the maintenance region.

However, in a case of such a printing apparatus, another region used to dispose the mirror needs to be separately provided. This may cause an increase in the size of the printing apparatus. Thus, it is desired to improve maintainability without causing an increase in the size of the printing apparatus.

### SUMMARY

A printing apparatus that solves the problem described above includes an attachment unit configured to enable a medium support portion to be attached and detached, the medium support portion including a support face configured to support a medium, a head configured to discharge a liquid to the medium supported by the support face, a first movement unit configured to move the head in a first direction parallel to the support face, a second movement unit configured to move the head in a second direction, the second direction being parallel to the support face and intersecting the first direction, a control unit configured to control the first movement unit and the second movement unit, an input unit configured to enable a user to input an instruction, and a notification unit configured to give notification of information, in which the head is configured to move to an opposed region in which the head is opposed to the support face, and when a movement instruction is inputted into the input unit, the notification unit gives notification that prompts the user to detach the medium support portion from the attachment unit, and the control unit causes the head to move from a standby position not included in the opposed region, to a cleaning position, a portion of or whole of the cleaning position being included in the opposed region.

A printing apparatus that solves the problem described above includes a medium support portion including a support face configured to support a medium, a position adjustment unit configured to adjust a position of the medium support portion in a vertical direction, a head configured to discharge a liquid to the medium supported by the support face, a first movement unit configured to move the head in a first direction parallel to the support face, a second movement unit configured to move the head in a second direction, the second direction being parallel to the support face and intersecting the first direction, a control unit configured to control the first movement unit and the second movement unit, and an input unit configured to enable a user to input an instruction, in which the head is configured to move to an opposed region in which the head is opposed to the support face, and when a movement instruction is inputted into the input unit, the control unit causes the head to move from a standby position not included in the opposed region, to a cleaning position in a state in which the medium support portion is lowered to a position lower than a highest position, a portion of or whole of the cleaning position being included in the opposed region.

A method of controlling a printing apparatus that solves the problem described above includes, when a movement instruction is inputted by a user, performing, by a notification unit of the printing apparatus, notification that prompts the user to detach a medium support portion including a support face configured to support a medium, and causing, by a control unit of the printing apparatus, a head to move in a first direction parallel to the support face and also in a second direction, the head being configured to discharge a liquid to the medium supported by the medium support portion, the second direction being parallel to the support face and intersecting the first direction, thereby causing the head to move from a standby position not included in an opposed region in which the head is opposed to the support face, to a cleaning position, a portion of or whole of the cleaning position being included in the opposed region.

A method of controlling a printing apparatus that solves the problem described above includes, when a movement instruction is inputted by a user, causing, by a control unit of the printing apparatus, a head to move in a first direction parallel to a support face configured to support a medium and also in a second direction in a state in which a medium support portion including the support face is lowered to a position lower than a highest position, the head being configured to discharge a liquid to the medium, the second direction being parallel to the support face and intersecting the first direction, thereby causing the head to move from a standby position not included in an opposed region in which the head is opposed to the support face, to a cleaning position, a portion of or whole of the cleaning position being included in the opposed region.

### BRIEF DESCRIPTION OF THE DRAWINGS

FIG. 1 is a perspective view of a printing apparatus.

FIG. 2 is a perspective view of the printing apparatus.

FIG. 3 is a schematic diagram illustrating a movement region of a head.

FIG. 4 is a front view of the printing apparatus.

FIG. 5 is a front view of the printing apparatus.

FIG. 6 is a perspective view of the printing apparatus.

FIG. 7 is a block diagram illustrating an electrical configuration of the printing apparatus.

FIG. 8 is a flowchart showing a cleaning control process.

FIG. 9 is a flowchart showing a cleaning control process.

### DESCRIPTION OF EMBODIMENTS

### First Embodiment

One embodiment of a printing apparatus and a method of controlling a printing apparatus will be described below. In the following description, a direction intersecting a vertical direction Z is referred to as a width direction X, and a direction intersecting the vertical direction Z and the width direction X is referred to as a front-rear direction Y. One side in the width direction X is referred to as a first width direction X1, and the other side in the width direction X is referred to as a second width direction X2. One side in the front-back direction Y is referred to as a forward direction Y1, and the other side in the front-rear direction Y is referred to as a rearward direction Y2. The upward direction in the vertical direction Z is referred to as the upward direction Z1, and the downward direction in the vertical direction z is referred to as a downward direction 22. The width direction X corresponds to one example of a first direction. The first width direction X1 corresponds to one direction in the first direction. The front-rear direction Y corresponds to one example of a second direction.

### Printing Apparatus 10

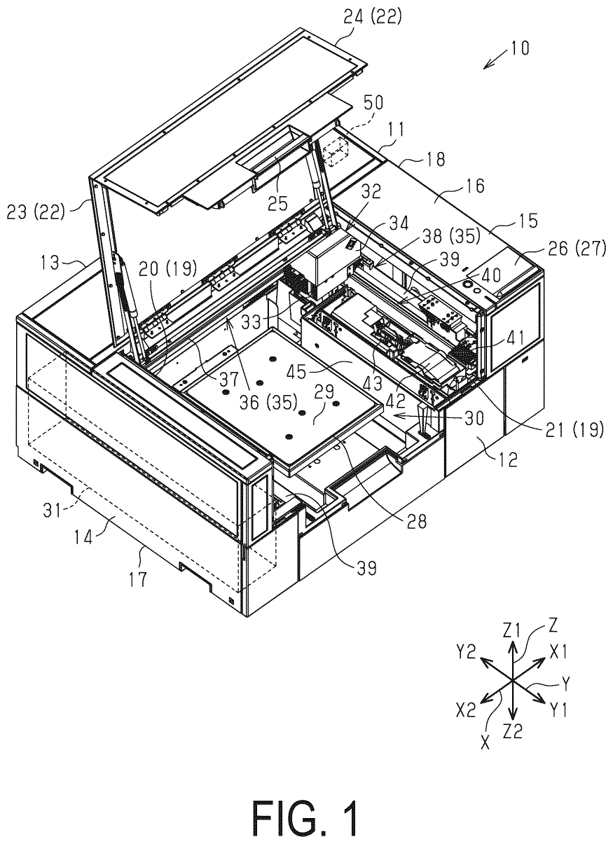

As illustrated in FIG. 1, a printing apparatus 10 is configured to perform printing on a medium. The printing apparatus 10 may be configured so as to discharge a liquid to perform printing on a medium. The printing apparatus 10 may be configured to perform printing on a medium having flexibility such as a T-shirt, for example. The printing apparatus 10 may be configured such that a medium is placed in the interior thereof by a user.

### Housing 11

The printing apparatus 10 includes a housing 11. The housing 11 may have a rectangular shape. The housing 11 includes a front face 12 facing the forward direction Y1. The housing 11 includes a back surface 13 facing the rearward direction Y2. The housing 11 includes a left-side surface 14 facing the second width direction X2. The housing 11 includes a right-side surface 15 facing the first width direction X1. The housing 11 includes a top surface 16 facing the upward direction Z1. The housing 11 includes a bottom surface 17 facing the downward direction 22. The front face 12 corresponds to one example of a side surface.

The housing 11 is configured to accommodate various members included in the printing apparatus 10. In particular, the housing 11 accommodates a medium support portion 28, a liquid supply unit 31, a printing unit 32, and a maintenance unit 40, which will be described later.

The housing 11 includes a housing frame 18. The housing frame 18 constitutes an outer packaging of the housing 11. The housing frame 18 includes an opening portion 19. In other words, the housing 11 includes the opening portion 19. The opening portion 19 is configured so as to expose various types of members accommodated in the housing 11. In particular, the opening portion 19 is configured so as to expose the support face 29 of a medium support portion 28 that will be described later.

The opening portion 19 includes a first opening portion 20 and a second opening portion 21. The first opening portion 20 is provided in the top surface 16. The second opening portion 21 is provided in the front face 12. The opening portion 19 opens a part of the top surface 16 and a part of the front face 12. The first opening portion 20 and the second opening portion 21 are provided so as to be continuous with each other. In other words, the opening portion 19 is provided across the top surface 16 and the front surface 12.

The housing 11 includes an open-close cover 22. The open-close cover 22 is able to open and close the opening portion 19. The open-close cover 22 may be formed of a sheet metal in order to secure rigidity. The open-close cover 22 includes a first open-close cover 23. The first open-close cover 23 has a flat plate shape. The first open-close cover 23 is able to open and close the first opening portion 20.

The open-close cover 22 includes a second open-close cover 24. The second open-close cover 24 has a flat plate shape. The second open-close cover 24 is able to open and close the second opening portion 21. The second open-close cover 24 includes a grip portion 25. The grip portion 25 is configured so as to be able to be gripped by a user.

The printing apparatus 10 includes a display unit 26 and an operation unit 27. The display unit 26 is configured so as to display information. The display unit 26 serves as one example of a notification unit. The notification unit functions so as to transmit information and prompt a user to take action. The operation unit 27 is configured such that a user is able to operate. The operation unit 27 corresponds to one example of an input unit configured such that a user is able to input an instruction. The display unit 26 and the operation unit 27 may be configured as an integrated unit such as a touch panel, or may be configured separately. The display unit 26 and the operation unit 27 are provided at the top surface 16. However, the configuration is not limited to this.

### Medium Support Portion 28

The printing apparatus 10 includes the medium support portion 28. The medium support portion 28 is configured to support a medium. The medium support portion 28 includes the support face 29. The support face 29 is a surface that faces the upward direction Z1. The support face 29 is configured so as to support a medium. In particular, the support face 29 is a surface that supports at least a printing region of the medium.

The medium support portion 28 is supported by a position adjustment unit 59 that will be described later. The medium support portion 28 is configured so as not to move in a horizontal direction parallel to the support face 29 in a state of being supported by the position adjustment unit 59. In other words, the support face 29 is configured so as not to move in the horizontal direction. The medium support portion 28 is configured such that the position, in the vertical direction Z, of the support face 29 is able to be adjusted by the position adjustment unit 59.

The printing apparatus 10 includes a medium accommodation unit 30. The medium accommodation unit 30 is accommodated in the housing 11. The medium accommodation unit 30 is provided at least in the width direction X of the support face 29, and may also be provided in the front-rear direction Y. When a region of a portion of the medium is supported by the support face 29, the medium accommodation unit 30 is able to accommodate a region of a portion of the medium that is not supported by the support face 29.

### Liquid Supply Unit 31

The printing apparatus 10 includes the liquid supply unit 31. The liquid supply unit 31 is provided further toward the second width direction X2 than the medium support portion 28 and the medium accommodation unit 30. The liquid supply unit 31 may be provided along the inner wall surface relative to the left-side surface 14. The liquid supply unit 31 is configured to accommodate a liquid and also supply the accommodated liquid to a head 33. The liquid supply unit 31 may be configured as a detachable cartridge type, or may be configured as a tank type in which a liquid can be replenished. The liquid supply unit 31 may be configured such that the top surface thereof has a flat surface.

### Printing Unit 32

The printing apparatus 10 includes the printing unit 32. The printing unit 32 is configured to perform printing on a medium. In particular, the printing unit 32 is configured to perform printing on a medium supported by the support face 29.

The printing unit 32 includes the head 33. In other words, the printing apparatus 10 includes the head 33. The head 33 is configured to discharge a liquid on a medium supported by the support face 29. The head 33 includes a plurality of nozzles (not illustrated) configured to discharge a liquid. The head 33 includes a nozzle surface (not illustrated) in which the plurality of nozzles are opened. The nozzle surface is a surface that faces the downward direction Z2.

The printing unit 32 includes a carriage 34. The carriage 34 is configured to support the head 33. The head 33 is configured as a serial type. The serial type is configured such that the head 33 performs printing while moving in the width direction X.

The printing unit 32 includes a movement unit 35. The movement unit 35 is configured so as to move the carriage 34. In other words, the movement unit 35 is configured so as to move the head 33. The movement unit 35 is configured so as to move the head 33 in the horizontal direction. Specifically, the movement unit 35 is configured so as to move the head 33 in the width direction X and the front-rear direction Y.

The movement unit 35 includes a first movement unit 36. In other words, the printing apparatus 10 includes the first movement unit 36. The first movement unit 36 is configured so as to move the carriage 34 in the width direction X. In other words, the first movement unit 36 is configured so as to move the head 33 in the width direction X parallel to the support face 29.

The first movement unit 36 includes a first guiding section 37. The first guiding section 37 is configured to extend in the width direction X across the support face 29. The first guiding section 37 guides the carriage 34 so as to be able to move along the width direction X.

The movement unit 35 includes a second movement unit 38. The printing apparatus 10 includes the second movement unit 38. The second movement unit 38 is configured to support the first movement unit 36. The second movement unit 38 is configured to move the first movement unit 36 in the front-rear direction Y. In other words, the second movement unit 38 is configured to move the head 33 in the front-rear direction Y parallel to the support face 29.

The second movement unit 38 includes a pair of second guide sections 39. The pair of second guide sections 39 are provided at the first width direction X1 and the second width direction X2 of the medium support portion 28 with the medium support portion 28 being interposed between the second guide sections. The pair of second guide sections 39 are each configured to extend in the front-rear direction Y.

In this manner, the movement unit 35 carries the head 33 and is movable in the horizontal direction across the medium support portion 28. The movement unit 35 is configured to have a gate-shape so as to extend over the medium support portion 28 in front view.

### Maintenance Unit 40

The printing apparatus 10 includes the maintenance unit 40. The maintenance unit 40 is provided further toward the first width direction X1 than the medium support portion 28 and the medium accommodation unit 30. The maintenance unit 40 is configured to extend in the front-rear direction Y. The maintenance unit 40 is disposed at a position that does not overlap with the medium support portion 28 nor the medium accommodation unit 30 in the vertical direction Z. The maintenance unit 40 is disposed at a position so as to be able to be opposed to the head 33 in the upward direction Z1. The maintenance unit 40 is configured to perform maintenance to the head 33.

The maintenance unit 40 includes a flushing unit 41. The flushing unit 41 is configured to receive the liquid discharged from the head 33. The flushing unit 41 is configured so as to be able to move in the front-rear direction Y together with the head 33. However, the flushing unit 41 may be configured so as to extend in the front-rear direction Y. In FIG. 1, the flushing unit 41 is illustrated so as not to be opposed to the head 33 for the purpose of convenience. However, the flushing unit 41 may operate in association with the movement of the head 33 relative to the front-rear direction Y so as to be opposed to the head 33. The flushing unit 41 may move in the front-rear direction Y with the same power source as the second movement unit 38, or may move in the front-rear direction Y with a power source differing from the second movement unit 38. The flushing unit 41 is disposed at a position that does not overlap with the medium support portion 28 nor the medium accommodation unit 30 in the vertical direction Z.

The maintenance unit 40 includes a wiping unit 42. The wiping unit 42 is able to wipe the nozzle surface. The wiping unit 42 is disposed at a position that does not overlap with the medium support portion 28 nor the medium accommodation unit 30 in the vertical direction Z.

The maintenance unit 40 includes a suction unit 43. The suction unit 43 is configured to perform suction of a liquid from the head 33. The suction unit 43 may include a suction pump configured to perform suction of a liquid from the head 33. The suction unit 43 is disposed at a position that does not overlap with the medium support portion 28 nor the medium accommodation unit 30 in the vertical direction Z.

In addition, the maintenance unit 40 may include a waste-liquid tank that is not illustrated. The waste-liquid tank is configured so as to store a liquid received by the flushing unit 41. The waste-liquid tank is configured so as to store the liquid suctioned by the suction unit 43. The waste-liquid tank is disposed at a position that does not overlap with the medium support portion 28 nor the medium accommodation unit 30 in the vertical direction Z.

### Maintenance Cover 44

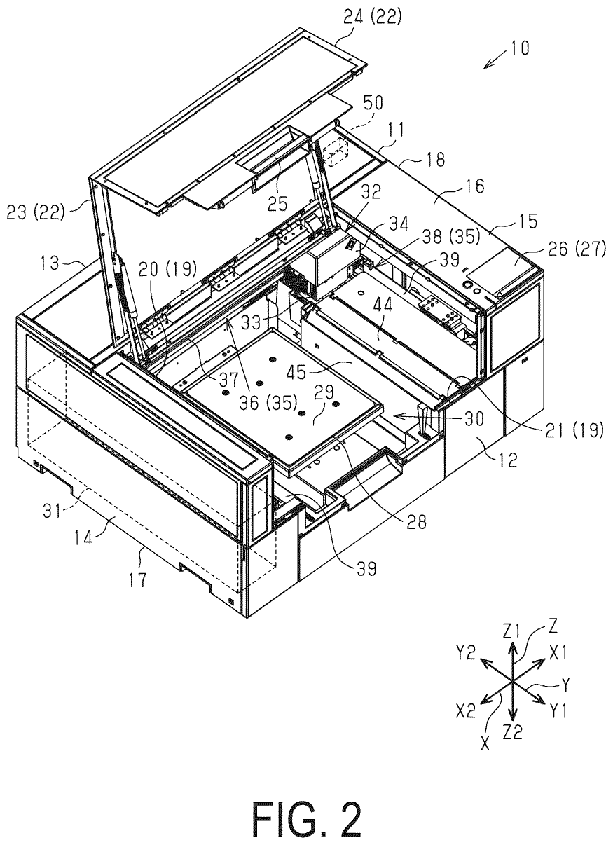

As illustrated in FIG. 2, the printing apparatus 10 includes a maintenance cover 44. The maintenance cover 44 is a cover that is able to cover the upward direction Z1 side of the maintenance unit 40.

The printing apparatus 10 includes a cover accommodation section 45. The cover accommodation section 45 is provided between the medium support portion 28 and the maintenance unit 40 and between the medium accommodation unit 30 and the maintenance unit 40 in the width direction X. The cover accommodation section 45 is able to accommodate the maintenance cover 44.

In this manner, the maintenance cover 44 is able to move to an open position illustrated in FIG. 1 and to a close position illustrated in FIG. 2. The open position is a position at which the maintenance unit 40 is opened. Specifically, the open position is a position at which the maintenance cover 44 does not cover the upward direction Z1 side of the maintenance unit 40 and the maintenance cover 44 is accommodated in the cover accommodation section 45. The close position is a position at which the maintenance unit 40 is closed. Specifically, the close position is a position at which the maintenance cover 44 covers the upward direction Z1 side of the maintenance unit 40.

### Control Unit 50

The printing apparatus 10 includes a control unit 50. The control unit 50 controls the printing apparatus 10. In particular, the control unit 50 controls at least the first movement unit 36 and the second movement unit 38. The control unit 50 controls various types of operations performed in the printing apparatus 10. It is possible to configure the control unit 50 as a circuit including α: one or more processors configured to perform various types of processes in accordance with a computer program, β: one or more dedicated hardware circuits configured to perform at least a portion of process from among various types of processes, and γ: a combination of these processors and circuits. The hardware circuit is an application specific integrated circuit, for example. The processor includes a CPU and a memory such as an RAM or a ROM. The memory holds a program code or an instruction configured to cause the CPU to perform a process. The memory, that is, a computer readable medium includes any types of readable medium to which a general-type or dedicated computer can access.

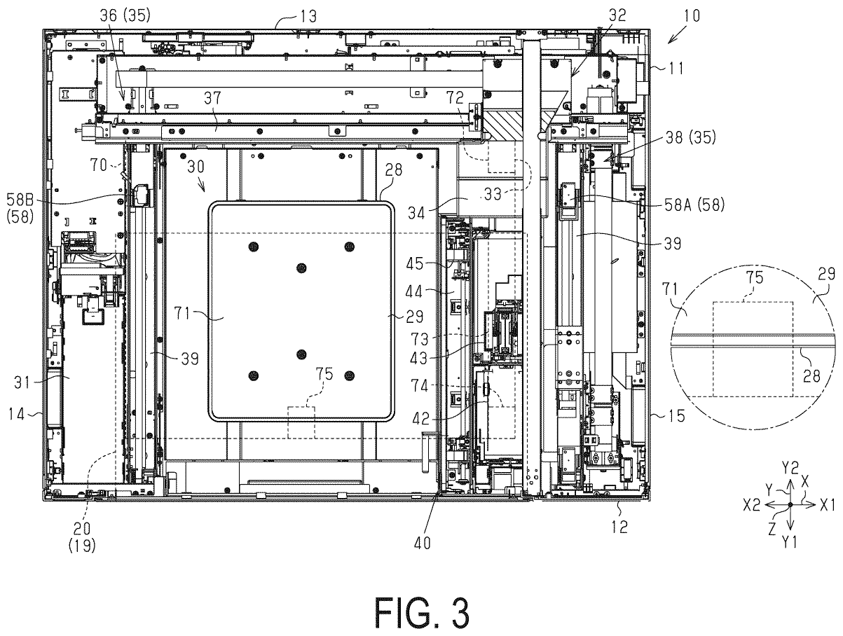

As illustrated in FIG. 3, the printing apparatus 10 includes an interference detector 58. The interference detector 58 detects the presence or absence of an interfering object that may interfere with the head 33 at the slightly downward direction 22 of the nozzle surface of the head 33. In other words, the interference detector 58 is configured so as to detect interference against the head 33. The interference detector 58 may include a light emitting unit 58A and a light-receiving unit 58B.

The interference detector 58 is supported by the second movement unit 38. With this configuration, the interference detector 58 operates in association with the second movement unit 38. In other words, the interference detector 58 operates in association with movement of the head 33 in the front-rear direction Y.

The interference detector 58 is disposed more toward the forward direction Y1 than the head 33. Thus, by moving in the forward direction Y1 in conjunction with the head 33 using the second movement unit 38, the interference detector 58 is able to detect interference of an interfering object with the head 33 before the interfering object actually interferes with the head 33.

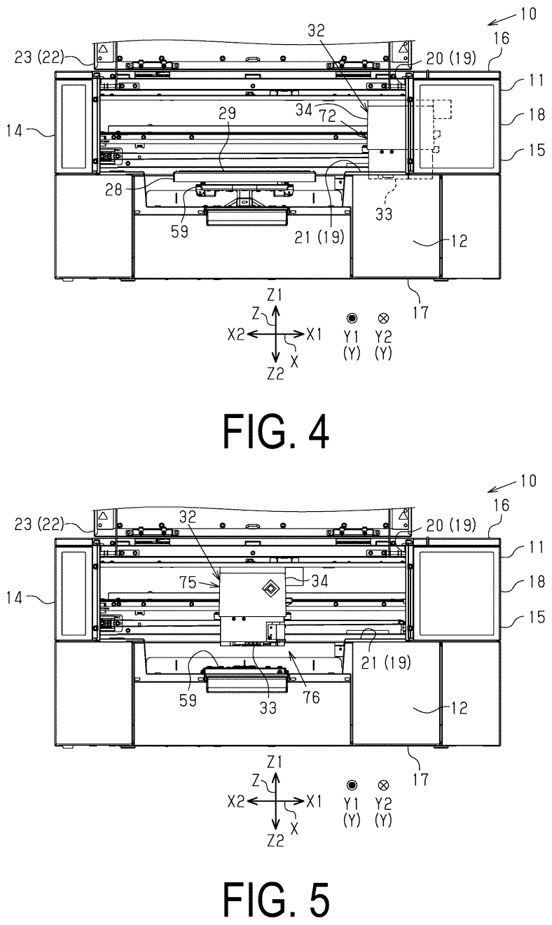

As illustrated in FIG. 4, the printing apparatus 10 includes the position adjustment unit 59. The position adjustment unit 59 supports the medium support portion 28. The position adjustment unit 59 is configured so as to adjust the position of the medium support portion 28 in the vertical direction Z. In other words, the position adjustment unit 59 is able to adjust the position of the support face 29 in the vertical direction Z. Thus, the position adjustment unit 59 is configured so as to adjust the space between the head 33 and the support face 29 in the vertical direction Z. In addition, the medium support portion 28 is able to be attached to and detached from the position adjustment unit 59. That is, the medium support portion 28 is able to be attached to and detached from the housing 11. The position adjustment unit 59 corresponds to one example of an attachment unit.

### Movement Region 70 of Head 33

Here, a movement region 70 of the head 33 will be described with reference to FIGS. 3 to 6.

As illustrated in FIG. 3, the head 33 is able to move in the predetermined movement region 70. The movement region 70 includes an opposed region 71. In other words, the head 33 is able to move in the opposed region 71. The opposed region 71 is a region in which the nozzle surface of the head 33 is opposed to the support face 29. The opposed region 71 includes a printing region in which printing is performed on a medium.

The movement region 70 includes a standby position 72. The standby position 72 is a position at which the head 33 is disposed when no printing is performed. The standby position 72 is a region in which the nozzle surface of the head 33 is not opposed to the support face 29. In other words, the standby position 72 is not included in the opposed region 71. The standby position 72 may be disposed at the first width direction X1 side and also at the rearward direction Y2 side of the movement region 70. The standby position 72 is provided further toward the first width direction X1 than the medium support portion 28.

The movement region 70 includes a maintenance region 73. The maintenance region 73 is disposed in the upward direction Z1 of the maintenance unit 40. The maintenance region 73 is a region in which the nozzle surface of the head 33 is not opposed to the support face 29. In other words, the maintenance region 73 is not included in the opposed region 71. The maintenance region 73 is a region in which the nozzle surface of the head 33 is opposed to the maintenance unit 40. Note that, in FIG. 3, the flushing unit 41 is not illustrated for the purpose of convenience.

The movement region 70 includes a most forward position 74. The most forward position 74 is included in the maintenance region 73. In other words, the most forward position 74 is included in the opposed region 71. The most forward position 74 is disposed at the first width direction X1 side and also at the forward direction Y1 side of the movement region 70. The most forward position 74 is disposed in the forward direction Y1 of the standby position 72.

The movement region 70 includes a cleaning position 75. A portion of the head 33 disposed at the cleaning position 75 is included in the opposed region 71 as viewed from the upward direction Z1. In other words, a portion of the cleaning position 75 is included in the opposed region 71 as viewed from the upward direction Z1. The cleaning position 75 is disposed at the forward direction Y1 of the opposed region 71 as viewed from the upward direction Z1. The cleaning position 75 is disposed in the rearward direction Y2 of the second opening portion 21 as viewed from the upward direction Z1.

The cleaning position 75 is a position to which the head 33 moves when control turns into a cleaning mode. The cleaning mode is a mode used to clean the head 33. In the cleaning mode, the head 33 may be cleaned, for example, such that a user wipes it using a cloth.

When a movement instruction is inputted into the operation unit 27 to turn control into the cleaning mode, the head 33 moves in the forward direction Y1 from the standby position 72. With this operation, the head 33 moves along the front-rear direction Y from the standby position 72 through the maintenance region 73 to the most forward position 74. In this case, when the head 33 moves from the standby position 72 to the most forward position 74, the interference detector 58 is able to detect interference against the head 33. After reaching the most forward position 74, the head 33 moves along the width direction X from the most forward position 74 to the cleaning position 75. It may be possible to say that the most forward position 74 is an intermediate position between the standby position 72 and the cleaning position 75.

As illustrated in FIGS. 4 and 5, the cleaning mode is a mode in which the position adjustment unit 59 is displaced from the highest position illustrated in FIG. 4 to the lowest position illustrated in FIG. 5 before the head 33 is moved from the standby position 72 to the cleaning position 75. The highest position is a position at which the medium support portion 28 attached to the position adjustment unit 59 is disposed at the highest position. The highest position is a position when a medium is placed on the medium support portion 28. The lowest position is a position at which the medium support portion 28 attached to the position adjustment unit 59 is disposed at the lowest position. The cleaning mode is a mode in which detaching the medium support portion 28 from the position adjustment unit 59 is recommended.

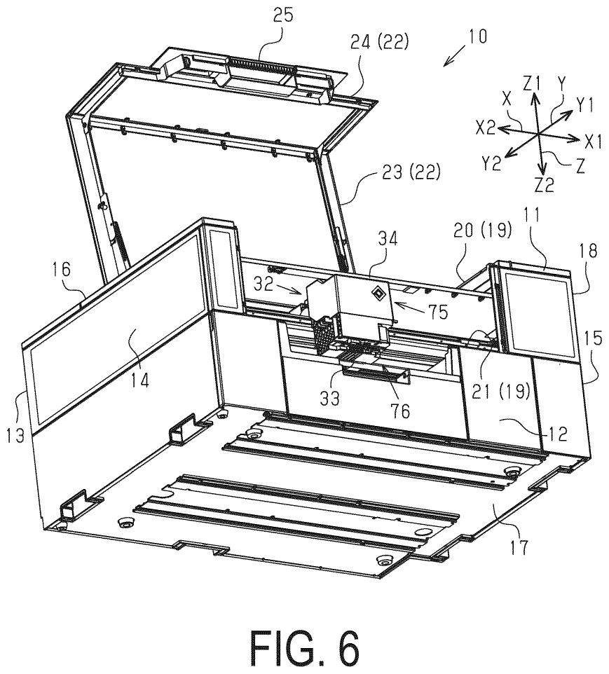

When the head 33 is disposed at the cleaning position 75, a space 76 exists at the downward direction 22 of the head 33, as illustrated in FIGS. 5 and 6. Since the position adjustment unit 59 is moved to the lowest position and the medium support portion 28 is detached, the space 76 further increases. In addition, the space 76 communicates with the second opening portion 21. Thus, for the printing apparatus 10, it is easy to clean the head 33 from the outside of the housing 11.

### Electrical Configuration of Printing Apparatus 10

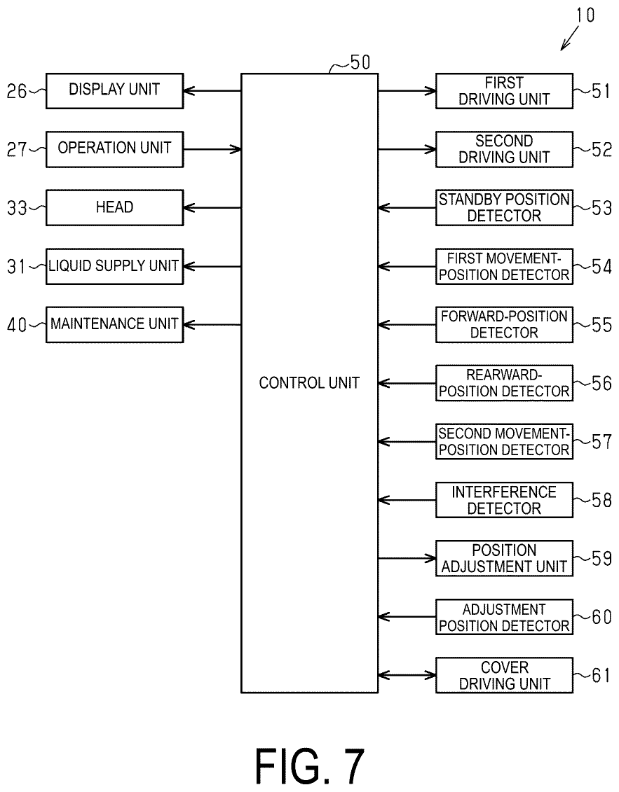

Next, the electrical configuration of the printing apparatus 10 will be described with reference to FIG. 7.

As illustrated in FIG. 7, the printing apparatus 10 includes a first driving unit 51. The first driving unit 51 is a drive source configured to move the carriage 34 along the width direction X. The first driving unit 51 may be provided at the first movement unit 36.

The printing apparatus 10 includes a second driving unit 52. The second driving unit 52 is a drive source configured to move the first movement unit 36 in the front-rear direction Y. The second driving unit 52 may be provided at the second movement unit 38.

The printing apparatus 10 includes a standby position detector 53. The standby position detector 53 is able to detect that the head 33 is disposed at the standby position 72. The standby position detector 53 may be provided at the first movement unit 36.

The printing apparatus 10 includes a first movement-position detector 54. The first movement-position detector 54 is able to detect the position, in the width direction X, at which the head 33 moving in the width direction X is disposed. The first movement-position detector 54 may be provided at the first movement unit 36.

The printing apparatus 10 includes a forward-position detector 55. The forward-position detector 55 is able to detect that the head 33 is disposed at the most forward position 74. The forward-position detector 55 may be provided at the second movement unit 38.

The printing apparatus 10 includes a rearward-position detector 56. The rearward-position detector 56 is able to detect that the head 33 is disposed at the rearmost position. The rearward-position detector 56 may be provided at the second movement unit 38.

The printing apparatus 10 includes a second movement-position detector 57. The second movement-position detector 57 is able to detect a position, in the front-rear direction Y, at which the head 33 is disposed. The second movement-position detector 57 may be provided at the second movement unit 38. In other words, the second movement-position detector 57 is configured to detect the position of the head 33 in the front-rear direction Y.

The printing apparatus 10 includes an adjustment position detector 60. The adjustment position detector 60 is able to detect the position, in the vertical direction Z, of the support face 29. In other words, the adjustment position detector 60 is configured so as to detect the distance between the support face 29 and the nozzle surface. The adjustment position detector 60 may be provided at the position adjustment unit 59.

The printing apparatus 10 includes a cover driving unit 61. The cover driving unit 61 is a drive source configured to open and close the maintenance cover 44. In this manner, the cover driving unit 61 displaces the maintenance cover 44 to the open position and the close position. In other words, the cover driving unit 61 moves the maintenance cover 44.

The control unit 50 is coupled to the display unit 26, the head 33, the first driving unit 51, the second driving unit 52, the position adjustment unit 59, the cover driving unit 61, the liquid supply unit 31, and the maintenance unit 40. The control unit 50 causes the display unit 26 to display various types of images. The control unit 50 supplies a drive signal to control the head 33, the first driving unit 51, the second driving unit 52, the position adjustment unit 59, the cover driving unit 61, the liquid supply unit 31, and the maintenance unit 40. In particular, the control unit 50 controls the first driving unit 51, thereby controlling the first movement unit 36. The control unit 50 controls the second driving unit 52, thereby controlling the second movement unit 38. The control unit 50 controls the cover driving unit 61, thereby controlling the maintenance cover 44.

The control unit 50 is coupled to the operation unit 27, the standby position detector 53, the first movement-position detector 54, the forward-position detector 55, the rearward-position detector 56, the second movement-position detector 57, the interference detector 58, and the adjustment position detector 60. The control unit 50 is able to receive an operation signal from the operation unit 27. The control unit 50 is able to receive detection signals from the standby position detector 53, the first movement-position detector 54, the forward-position detector 55, the rearward-position detector 56, the second movement-position detector 57, the interference detector 58, and the adjustment position detector 60.

The control unit 50 performs various types of control on the basis of the operation signals and the detection signals. As for one specific example, when a printing instruction is inputted, the control unit 50 controls the head 33, the first movement unit 36, and the second movement unit 38 so as to perform printing on a medium, on the basis of image data included in the printing instruction.

### Cleaning-Mode Control Process

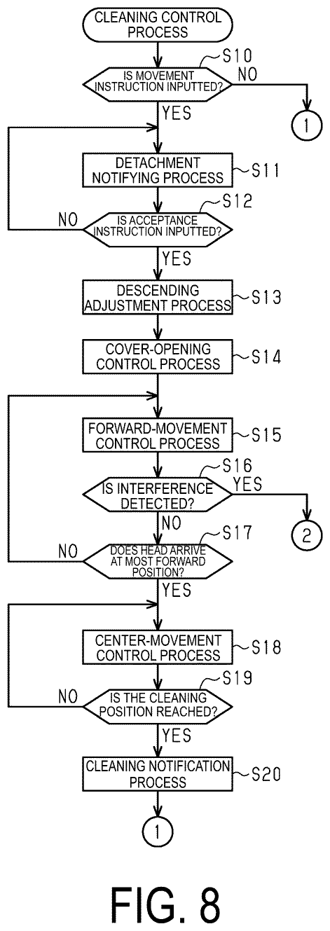

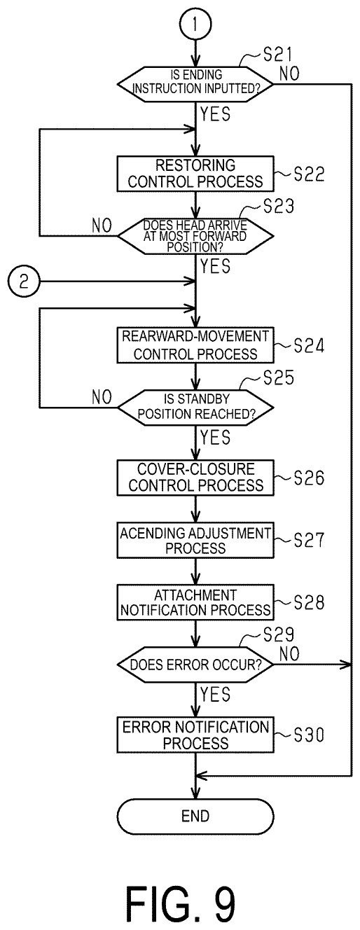

Next, a cleaning-mode control process will be described with reference to FIGS. 8 and 9. The cleaning-mode control process is a process that is performed by the control unit 50 for every predetermined cycle. Here, the order of individual processes is able to be appropriately swapped, provided that the swapping does not cause any deviation from the purpose of each of the processes.

As illustrated in FIG. 8, in step S10, the control unit 50 determines whether or not a movement instruction is inputted, on the basis of the operation signal from the operation unit 27. The movement instruction is an instruction given by a user to control the cleaning mode. When determining that the movement instruction is not inputted, the control unit 50 moves the process to step S21 in FIG. 9. When determining that the movement instruction is inputted, the control unit 50 moves the process to step S11.

In step S11, the control unit 50 performs a detachment notifying process. In the detachment notifying process, the control unit 50 causes the display unit 26 to display an image in which detaching the medium support portion 28 from the position adjustment unit 59 is prompted.

In step S12, the control unit 50 determines whether or not an acceptance instruction is inputted, on the basis of the operation signal from the operation unit 27. The acceptance instruction is an instruction indicating that movement of the head 33 to the cleaning position 75 is accepted. A user inputs the acceptance instruction after detaching the medium support portion 28 from the position adjustment unit 59. When determining that the acceptance instruction is not inputted, the control unit 50 moves the process to step S11 again. When determining that the acceptance instruction is inputted, the control unit 50 moves the process to step S13.

In step S13, the control unit 50 performs a descending adjustment process. In the descending adjustment process, the control unit 50 performs control such that the position adjustment unit 59 descends to the lowest position. This further increases the size of the space 76 at the downward direction Z2 of the head 33 when the head 33 moves to the cleaning position 75.

In step S14, the control unit 50 performs a cover-opening control process. In the cover-opening driving process, the control unit 50 controls the cover driving unit 61 such that the maintenance cover 44 moves from the close position to the open position. In this manner, when the movement instruction is inputted, the control unit 50 controls the cover driving unit 61 such that the maintenance cover 44 moves to the open position.

In step S15, the control unit 50 performs a forward-movement control process. In the forward-movement control process, the control unit 50 controls the second driving unit 52 such that the head 33 moves in the forward direction Y1.

In step S16, the control unit 50 determines whether or not interference against the head 33 is detected, on the basis of the detection signal from the interference detector 58. In this manner, when the movement instruction is inputted, the control unit 50 determines interference against the head 33 on the basis of a result of detection by the interference detector 58. When determining that interference against the head 33 is detected, the control unit 50 determines that an error occurs on the basis of the detection of interference, and moves the process to step S24 in FIG. 9. On the other hand, when determining that no interference against the head 33 is detected, the control unit 50 moves the process to step S17.

In step S17, the control unit 50 determines whether or not the head 33 reaches the most forward position 74, on the basis of the detection signal from the forward-position detector 55. In other words, the control unit 50 moves the interference detector 58 together with the head 33 in the forward direction Y1 until the head 33 reaches the most forward position 74 from the standby position 72, thereby determining whether or not the process of detecting interference against the head 33 is complete. When determining that the head 33 has not yet reached the most forward position 74, the control unit 50 moves the process to step S15 again. On the other hand, when determining that the head 33 has reached the most forward position 74, the control unit 50 moves the process to step S18.

In step S18, the control unit 50 performs a center-movement control process. In the center-movement control process, the control unit 50 controls the first driving unit 51 such that the head 33 is moved in the second width direction X2 by the first movement unit 36.

In step S19, the control unit 50 determines whether or not the head 33 reaches the cleaning position 75, on the basis of the detection signal from the first movement-position detector 54. When determining that the head 33 has not yet reached the cleaning position 75, the control unit 50 moves the process to step S18 again. When determining that the head 33 has reached the cleaning position 75, the control unit 50 moves the process to step S20. In this manner, the control unit 50 moves the head 33 in the second width direction X2 until the head 33 reaches the cleaning position 75.

In step S20, the control unit 50 performs a cleaning notification process. In the cleaning notification process, the control unit 50 causes the display unit 26 to display an image indicating that the head 33 has moved to the cleaning position 75. The control unit 50 causes the display unit 26 to display an image in which cleaning the head 33 is prompted.

In this manner, when a movement instruction is inputted, the display unit 26 performs display that prompts a user to detach the medium support portion 28 from the position adjustment unit 59, and the control unit 50 moves the head 33 from the standby position 72 to the cleaning position 75. In addition, when the movement instruction is inputted, the control unit 50 causes the head 33 to move from the standby position 72 to the cleaning position 75 in a state in which the medium support portion 28 is lowered to the lowest position. In particular, the control unit 50 causes the head 33 to move such that the head 33 is opposed to the maintenance unit 40 while moving the head 33 from the standby position 72 to the cleaning position 75.

As illustrated in FIG. 9, in step S21, the control unit 50 determines whether or not an ending instruction is inputted, on the basis of the operation signal from the operation unit 27. The ending instruction is an instruction made by a user to end the cleaning mode. When determining that the ending instruction is not inputted, the control unit 50 ends the cleaning control process. When determining that the ending instruction is inputted, the control unit 50 moves the process to step S22.

In step S22, the control unit 50 performs a restoring control process. In the restoring control process, the control unit 50 controls the first driving unit 51 such that the head 33 moves in the first width direction X1 by the first movement unit 36.

In step S23, the control unit 50 determines whether or not the head 33 reaches the most forward position 74, on the basis of the detection signal from the first movement-position detector 54. When determining that the head 33 has not yet reached the most forward position 74, the control unit 50 moves the process to step S22 again. When determining that the head 33 has reached the most forward position 74, the control unit 50 moves the process to step S24. In this manner, the control unit 50 moves the head 33 in the first width direction X1 until the head 33 reaches the most forward position 74.

In step S24, the control unit 50 performs a rearward-movement control process. In the rearward-movement control process, the control unit 50 controls the second driving unit 52 such that the head 33 moves in the rearward direction Y2.

In step S25, the control unit 50 determines whether or not the head 33 reaches the standby position 72, on the basis of the detection signal from the rearward-position detector 56. When determining that the head 33 has not yet reached the standby position 72, the control unit 50 moves the process to step S24 again. On the other hand, when determining that the head 33 has reached the standby position 72, the control unit 50 moves the process to step S26.

In step S26, the control unit 50 performs a cover-closure control process. In a cover-closure driving process, the control unit 50 controls the cover driving unit 61 such that the maintenance cover 44 moves from the open position to the close position. In this manner, when the ending instruction is inputted, the control unit 50 controls the cover driving unit 61 so as to move the maintenance cover 44 to the close position.

In step S27, the control unit 50 performs an ascending adjustment process. In the ascending adjustment process, the control unit 50 performs control such that the position adjustment unit 59 ascends to the highest position. With this configuration, it is easy to place a medium at the medium support portion 28 when the medium support portion 28 is attached to the position adjustment unit 59.

In step S28, the control unit 50 performs an attachment notification process. In the attachment notification process, the control unit 50 causes the display unit 26 to display an image in which attaching the medium support portion 28 to the position adjustment unit 59 is prompted.

In step S29, the control unit 50 determines whether or not an error occurs on the basis of the detection of interference. When determining that no error occurs, the control unit 50 ends the cleaning control process. When determining that an error occurs, the control unit 50 moves the process to step S30.

In step S30, the control unit 50 performs an error notification process. In the error notification process, the control unit 50 causes the display unit 26 to display an image indicating that an error occurs on the basis of detection of interference. The control unit 50 causes the display unit 26 to display an image in which removing an interfering object relative to the head 33 is prompted.

### Operations of First Embodiment

Operations of the first embodiment will be described.

When a movement instruction is inputted through operation made by a user to the operation unit 27, the display unit 26 displays an image in which detaching the medium support portion 28 is prompted. After the medium support portion 28 is detached from the position adjustment unit 59 by a user and an acceptance instruction is inputted through operation made by the user to the operation unit 27, the position adjustment unit 59 descends to the lowest position, and the maintenance cover 44 moves to the open position. Then, the head 33 starts to move from the standby position 72 to the most forward position 74. During movement from the standby position 72 to the most forward position 74, the head 33 passes through the maintenance region 73.

During a period of time when the head 33 moves from the standby position 72 to the most forward position 74, when interference against the head 33 is detected on the basis of a result of detection by the interference detector 58, the head 33 returns to the standby position 72 to display an image indicating that an error occurs on the basis of detection of interference.

When the head 33 reaches the most forward position 74 without occurrence of any error on the basis of detection of interference, the head 33 moves from the most forward position 74 to the cleaning position 75. When the head 33 is disposed at the cleaning position 75, the display unit 26 displays an image in which cleaning of the head 33 is prompted. With this operation, the head 33 moves from the standby position 72 not included in the opposed region 71 to the cleaning position 75 included in the opposed region 71.

When the head 33 is disposed at the cleaning position 75, the space 76 extends in the downward direction 22 of the head 33. In particular, when the head 33 is disposed at the cleaning position 75, the medium support portion 28 does not exist at the downward direction Z2 of the head 33, and the position adjustment unit 59 is disposed at the lowest position. Thus, the space 76 existing at the downward direction Z2 of the head 33 increases, as compared with the case where printing is performed on a medium. This makes it possible to secure a space used to maintain the head 33 without providing a dedicated maintenance region. In addition, the cleaning position 75 is disposed at the rearward direction Y2 of the second opening portion 21. This configuration makes it easy for a user to clean the head 33 from the outside of the housing 11.

When the ending instruction is inputted through operation made by a user to the operation unit 27, the head 33 moves from the cleaning position 75 to the most forward position 74. When the head 33 has reached the most forward position 74, the head 33 moves from the most forward position 74 to the standby position 72. Then, the position adjustment unit 59 ascends to the highest position, and the maintenance cover 44 moves to the close position. In addition, the display unit 26 displays an image in which attaching the medium support portion 28 to the position adjustment unit 59 is prompted. Then, the medium support portion 28 is attached to the position adjustment unit 59 by the user.

### Effects of First Embodiment

Effects of the first embodiment will be described.
(1) When a movement instruction is inputted, the control unit 50 moves the head 33 from the standby position 72 not included in the opposed region 71 to the cleaning position 75 included in the opposed region 71. With this configuration, by moving the head 33 to the cleaning position 75 included in the opposed region 71, it is possible to clean the head 33 even if the cleaning position is not provided in a region not included in the opposed region 71. In addition, a user is prompted to detach the medium support portion 28 from the position adjustment unit 59, and the medium support portion 28 is detached from the position adjustment unit 59. In this state, the space 76 used to clean the head 33 can be expanded between the head 33 and the position adjustment unit 59. This makes it possible to improve the maintainability without increasing the size of the printing apparatus 10.
(2) When a movement instruction is inputted, the control unit 50 moves the head 33 from the standby position 72 to the cleaning position 75 in a state in which the medium support portion 28 is lowered to the lowest position. With this configuration, even if the cleaning position 75 is not provided in a region not included in the opposed region 71, it is possible to clean the head 33 by moving the head 33 to the cleaning position 75 included in the opposed region 71. In addition, by lowering the medium support portion 28 to a position lower than the highest position in the downward direction Z2, the space 76 used to clean the head 33 can be secured between the head 33 and the medium support portion 28. This makes it possible to improve the maintainability without increasing the size of the printing apparatus 10.
(3) The opening portion 19 opens a part of the top surface 16 and a part of the front face 12. The cleaning position 75 is disposed at the forward direction Y1 side of the opposed region 71. This configuration makes it easy to clean the head 33 from the outside of the housing 11 through the opening portion 19, by moving the head 33 to the cleaning position 75 included in the opposed region 71. This makes it possible to improve the maintainability without increasing the size of the printing apparatus 10.
(4) When a movement instruction is inputted, the control unit 50 moves the head 33 so as to be opposed to the maintenance unit 40 during movement of the head 33 from the standby position 72 to the cleaning position 75. With this configuration, even if a liquid drops from the head 33, it is possible to suppress spreading of the liquid within the housing 11, as compared with a case where the head 33 moves so as not to be opposed to the maintenance unit 40. This makes it possible to improve the maintainability.
(5) The maintenance cover 44 is able to move to the open position at which the maintenance unit 40 is opened and also to the close position at which the maintenance unit 40 is closed. When a movement instruction is inputted, the control unit 50 controls the cover driving unit 61 such that the maintenance cover 44 moves to the open position. This configuration makes it possible to suppress drying of the maintenance unit 40 by moving the maintenance cover 44 to the close position. In addition, when a movement instruction is inputted, it is possible to cause the maintenance unit 40 to be opposed to the head 33 by moving the maintenance cover 44 to the open position. With this configuration, even if a liquid drops from the head 33, it is possible to suppress spreading of the liquid coming from the head 33 within the printing apparatus 10 when the head 33 moves in the maintenance region 73. This makes it possible to improve the maintainability.
(6) The interference detector 58 operates in association with movement of the head 33 in the front-rear direction Y and detects interference against the head 33. When a movement instruction is inputted, the control unit 50 determines interference against the head 33, on the basis of a result of detection by the interference detector 58. This configuration makes it possible to move the head 33 while considering interference against the head 33. This makes it possible to improve the maintainability.

### Modifications

The embodiments may be modified in the following manner, and be implemented. The embodiments and modification examples described below may be combined with each other for implementation insofar as they are not technically contradict.
When a movement instruction is inputted, the control unit 50 may not cause the medium support portion 28 to be lowered to the lowest position. When a movement instruction is inputted, the control unit 50 may not perform control such that the maintenance cover 44 is at the open position.
The medium support portion 28 may be fixed to the position adjustment unit 59. In other words, the medium support portion 28 may not be able to be detached from the position adjustment unit 59. In this case, it is preferable that the control unit 50 should move the head 33 from the standby position 72 to the cleaning position 75 in a state in which the medium support portion 28 is lowered.
The control unit 50 may perform the descending adjustment process after the cover-opening control process ends. The control unit 50 may perform the descending adjustment process and the cover-opening control process at the same period. The control unit 50 may perform the cover-closure control process after the ascending adjustment process ends. The control unit 50 may perform the ascending adjustment process and the cover-closure control process at the same period.
The standby position 72 and the most forward position 74 may be disposed further toward the second width direction X2 than the opposed region 71. Although the most forward position 74 is set as the intermediate position, the configuration is not limited to this. For example, it may be possible to set the intermediate position as a position located further toward the rearward direction Y2 than the most forward position 74. In other words, the intermediate position may not be the most forward position 74.
The entire cleaning position 75 may be included in the opposed region 71. In other words, a part of or the whole of the cleaning position 75 may be included in the opposed region 71. A part of or the whole of the cleaning position 75 may be included in the opposed region 71 with the reference being the medium support portion 28 having the maximum size from among medium support portions 28 that can be attached to or detached from the position adjustment unit 59 of the printing apparatus 10. In other words, a part of or the whole of the cleaning position 75 may not be included in the opposed region 71 with the reference being the medium support portion 28 not having the maximum size from among medium support portions 28 that can be attached to or detached from the position adjustment unit 59 of the printing apparatus 10.
Various types of instructions may be inputted by a user in response to an operation made to a terminal device that can communicate with the printing apparatus 10. In this case, a communicating unit that can communicate with the printing apparatus 10 corresponds to one example of an input unit.
Before a movement instruction is inputted, the medium support portion 28 may be disposed at a position lower than the highest position. In the cleaning mode, it is only necessary that the position adjustment unit 59 is displaced such that the medium support portion 28 is lowered to a position higher than the lowest position.
The position adjustment unit 59 may not adjust the position, in the vertical direction Z, of the medium support portion 28, provided that the medium support portion 28 is configured to be detachable. In other words, it is only necessary that the position adjustment unit 59 is an attachment unit from which the medium support portion 28 is detachable.
The maintenance unit 40 may be disposed at the second width direction X2 of the medium support portion 28 in the movement region 70. The standby position 72 may be disposed at the second width direction X2 of the medium support portion 28 in the movement region 70. The standby position 72 may be disposed at the forward direction Y1 in the movement region 70.
It may be possible to employ a configuration in which the first opening portion 20 and the second opening portion 21 are not configured so as to be continuous with each other, and are provided separately. It may be possible to employ a configuration in which the opening portion 19 is not provided across the top surface 16 and the front face 12.
The opening portion 19 may be provided across the top surface 16, the front face 12, and other surfaces. In other words, the opening portion 19 may be provided at least across the top surface 16 and the front face 12. In addition, it may be possible to employ a configuration in which the opening portion 19 is provided in the top surface 16 and is not provided in the front face 12. That is, it is only necessary that the opening portion 19 is provided at least in the top surface 16.
The second opening portion 21 may be provided at any of the back surface 13, the left-side surface 14, and the right-side surface 15. In other words, any of the back surface 13, the left-side surface 14, and the right-side surface 15 may correspond to one example of a side surface. In this case, the cleaning position 75 may be allocated to a position at which the second opening portion 21 is provided.
The support face 29 is configured not to move in the horizontal direction. However, for example, the support surface 29 may be finely adjustable in the horizontal direction only when printing is not being performed, and it is only necessary that the support surface 29 be configured not to move in the horizontal direction at least when printing is being performed.
The first opening portion 20 may have a shape that is longer, in the front-rear direction Y, than the support surface 29 when viewed from the upward direction Z1.
The printing unit 32 may perform printing when the head 33 moves in either the first width direction X1 or the second width direction X2, or may perform printing both when the head 33 moves in the first width direction X1 and when the head 33 moves in the second width direction X2.
The head 33 may include a nozzle surface parallel to the horizontal plane or may include a nozzle surface sloped with respect to the horizontal plane.
The maintenance unit 40 may not include at least one of the flushing unit 41, the wiping unit 42, the suction unit 43, and the waste-liquid tank.
Instead of causing the display unit 26 to display an image, the control unit 50 may make notification, for example, through other methods such as sound, when prompting a user to transmit information and take action. That is, the notification unit may make notification also using a plurality of methods such as an image or sound.
The relationship between the width direction X and the front-rear direction Y in the present embodiment may be switched. In other words, the width direction X of the present embodiment may be the front-rear direction Y, and the front-rear direction Y of the present embodiment may be the width direction X.
The medium is not limited, for example, to the T-shirt, a polo shirt, or the like, and may be a sweatshirt, a hooded sweatshirt, or the like, for example, or may be a medium such as clothing. In addition, although the medium having flexibility is used as the medium, the medium is not limited to this example, and a medium having no flexibility, such as a smartphone case printed using UV ink, may be used, for example.
The printing apparatus 10 may be configured to discharge ink as one example of the liquid, but may be configured to discharge a liquid other than ink. In other words, it may be possible to select any liquid as appropriate as long as printing can be performed on the medium by causing the liquid to be attached on the medium.
The expression “at least one of” used in the present specification means one or more of desired options. As one example, when the number of options is two, the expression “at least one of” used in the present specification means only one option or both of the two options. As another example, when the number of options is three or more, the expression “at least one of” used in the present specification means only one option or any combination of two or more options.

### Note

Below, description will be made of the technical ideas and their operation and effects that can be obtained from the embodiments and modification examples described above.
(A) A printing apparatus includes: an attachment unit configured to enable a medium support portion to be attached and detached, the medium support portion including a support face configured to support a medium; a head configured to discharge a liquid to the medium supported by the support face; a first movement unit configured to move the head in a first direction parallel to the support face; a second movement unit configured to move the head in a second direction, the second direction being parallel to the support face and intersecting the first direction; a control unit configured to control the first movement unit and the second movement unit; an input unit configured to enable a user to input an instruction; and a notification unit configured to give notification of information, in which the head is configured to move to an opposed region in which the head is opposed to the support face, and when a movement instruction is inputted into the input unit, the notification unit gives notification that prompts the user to detach the medium support portion from the attachment unit, and the control unit causes the head to move from a standby position not included in the opposed region, to a cleaning position, a portion of or whole of the cleaning position being included in the opposed region.

With this configuration, even if the cleaning position is not provided in a region not included in the opposed region, it is possible to clean the head by moving the head to the cleaning position included in the opposed region. In addition, a user is prompted to detach the medium support portion from the attachment unit, and the medium support portion is detached from the adjustment unit. In this state, the space used to clean the head can be expanded between the head and the adjustment unit. Thus, it is possible to improve the maintainability without increasing the size of the printing apparatus.
(B) A printing apparatus includes: a medium support portion including a support face configured to support a medium; a position adjustment unit configured to adjust a position of the medium support portion in a vertical direction; a head configured to discharge a liquid to the medium supported by the support face; a first movement unit configured to move the head in a first direction parallel to the support face; a second movement unit configured to move the head in a second direction, the second direction being parallel to the support face and intersecting the first direction; a control unit configured to control the first movement unit and the second movement unit; and an input unit configured to enable a user to input an instruction, in which the head is configured to move to an opposed region in which the head is opposed to the support face, and when a movement instruction is inputted into the input unit, the control unit causes the head to move from a standby position not included in the opposed region, to a cleaning position in a state in which the medium support portion is lowered to a position lower than a highest position, a portion of or whole of the cleaning position being included in the opposed region.

With this configuration, even if the cleaning position is not provided in a region not included in the opposed region, it is possible to clean the head by moving the head to the cleaning position included in the opposed region. In addition, by lowering the medium support portion to a position lower than the highest position, it is possible to secure the space used to clean the head, between the head and the medium support portion. This makes it possible to improve the maintainability without increasing the size of the printing apparatus.
(C) The printing apparatus may be configured to include a housing at least accommodating the medium support portion, the head, the first movement unit, and the second movement unit, in which the housing includes a top surface, a side surface, and an opening portion, the opening portion opens a part of the top surface and a part of the side surface, and the cleaning position is disposed at a side of the side surface of the opening portion in the opposed region.

This configuration makes it easy to clean the head from the outside of the housing through the opening portion, by moving the head to the cleaning position included in the opposed region. This makes it possible to improve the maintainability without increasing the size of the printing apparatus.
(D) The printing apparatus is configured to include a maintenance unit configured to perform maintenance to the head, in which the maintenance unit is disposed further toward one direction of the first direction than the medium support portion, the standby position is disposed further toward one direction of the first direction than the medium support portion, and when a movement instruction is inputted into the input unit, the control unit causes the head to move to be opposed to the maintenance unit during movement of the head from the standby position to the cleaning position.

With this configuration, even if a liquid drops from the head when the head moves so as to be opposed to the maintenance unit, it is possible to suppress spreading of the liquid from the head within the printing apparatus. This makes it possible to improve the maintainability.
(E) The printing apparatus may be configured to include a maintenance cover and a cover driving unit, in which the maintenance cover is configured to move to an open position at which the maintenance unit is opened and also to a close position at which the maintenance unit is closed, the cover driving unit causes the maintenance cover to move, and when a movement instruction is inputted into the input unit, the control unit controls the cover driving unit to move the maintenance cover to the open position.

With this configuration, it is possible to suppress drying of the maintenance unit by moving the maintenance cover to the close position. In addition, when a movement instruction is inputted, it is possible to cause the maintenance unit to be opposed to the head by moving the maintenance cover to the open position. With this configuration, even if a liquid drops from the head when the head moves to the maintenance region, it is possible to suppress spreading of the liquid from the head within the printing apparatus. This makes it possible to improve the maintainability.
(F) The printing apparatus is configured to include an interference detector configured to detect interference with the head, in which the interference detector operates in association with movement of the head in the second direction, and when a movement instruction is inputted into the input unit, the control unit determines interference with the head, on a basis of a result of detection by the interference detector.

With this configuration, when a movement instruction is inputted, it is possible to operate in association with movement of the head in the second direction to determine interference against the head. This makes it possible to move the head while considering interference against the head. Thus, it is possible to improve the maintainability.
(G) A method of controlling a printing apparatus including: when a movement instruction is inputted by a user, performing, by a notification unit of the printing apparatus, notification that prompts the user to detach a medium support portion including a support face configured to support a medium; and causing, by a control unit of the printing apparatus, a head to move in a first direction parallel to the support face and also in a second direction, the head being configured to discharge a liquid to the medium supported by the medium support portion, the second direction being parallel to the support face and intersecting the first direction, thereby causing the head to move from a standby position not included in an opposed region in which the head is opposed to the support face, to a cleaning position, a portion of or whole of the cleaning position being included in the opposed region. This configuration provides the effect similar to that of (A) described above.
(H) A method of controlling a printing apparatus including: when a movement instruction is inputted by a user, causing, by a control unit of the printing apparatus, a head to move in a first direction parallel to a support face configured to support a medium and also in a second direction in a state in which a medium support portion including the support face is lowered to a position lower than a highest position, the head being configured to discharge a liquid to the medium, the second direction being parallel to the support face and intersecting the first direction, thereby causing the head to move from a standby position not included in an opposed region in which the head is opposed to the support face, to a cleaning position, a portion of or whole of the cleaning position being included in the opposed region. This configuration provides the effect similar to that of (B) described above.

What is claimed is:

1. A printing apparatus comprising:
an attachment unit configured to enable a medium support portion to be attached and detached, the medium support portion including a support face configured to support a medium;
a head configured to discharge a liquid to the medium supported by the support face;
a first movement unit configured to move the head in a first direction parallel to the support face;
a second movement unit configured to move the head in a second direction, the second direction being parallel to the support face and intersecting the first direction;
a control unit configured to control the first movement unit and the second movement unit;
an input unit configured to enable a user to input an instruction; and
a notification unit configured to give notification of information, wherein
the head is configured to move to an opposed region in which the head is opposed to the support face, and
when a movement instruction is inputted into the input unit, the notification unit gives notification that prompts the user to detach the medium support portion from the attachment unit, and the control unit causes the head to move from a standby position not included in the opposed region, to a cleaning position, a portion of or whole of the cleaning position being included in the opposed region.

2. A printing apparatus comprising:
a medium support portion including a support face configured to support a medium;
a position adjustment unit configured to adjust a position of the medium support portion in a vertical direction;
a head configured to discharge a liquid to the medium supported by the support face;
a first movement unit configured to move the head in a first direction parallel to the support face;
a second movement unit configured to move the head in a second direction, the second direction being parallel to the support face and intersecting the first direction;
a control unit configured to control the first movement unit and the second movement unit; and
an input unit configured to enable a user to input an instruction, wherein
the head is configured to move to an opposed region in which the head is opposed to the support face, and
when a movement instruction is inputted into the input unit, the control unit causes the head to move from a standby position not included in the opposed region, to a cleaning position in a state in which the medium support portion is lowered to a position lower than a highest position, a portion of or whole of the cleaning position being included in the opposed region.

3. The printing apparatus according to claim 1 further comprising:
a housing configured to at least accommodate the medium support portion, the head, the first movement unit, and the second movement unit, wherein
the housing includes a top surface, a side surface, and an opening portion,
the opening portion opens a part of the top surface and a part of the side surface, and
the cleaning position is disposed at a side of the side surface of the opening portion in the opposed region.

4. The printing apparatus according to claim 1 further comprising:
when a movement instruction is inputted into the input unit, the control unit determines interference against the head, on a basis of a result of detection by the interference detector.

7. A method of controlling a printing apparatus including:
when a movement instruction is inputted by a user,
performing, by a notification unit of the printing apparatus, notification that prompts the user to detach a medium support portion including a support face configured to support a medium; and
causing, by a control unit of the printing apparatus, a head to move in a first direction parallel to the support face and also in a second direction, the head being configured to discharge a liquid to the medium supported by the medium support portion, the second direction being parallel to the support face and intersecting the first direction, thereby causing the head to move from a standby position not included in an opposed region in which the head is opposed to the support face, to a cleaning position, a portion of or whole of the cleaning position being included in the opposed region.

8. A method of controlling a printing apparatus including:
when a movement instruction is inputted by a user,
causing, by a control unit of the printing apparatus, a head to move in a first direction parallel to a support face configured to support a medium and also in a second direction in a state in which a medium support portion including the support face is lowered to a position lower than a highest position, the head being configured to discharge a liquid to the medium, the second direction being parallel to the support face and intersecting the first direction, thereby causing the head to move from a standby position not included in an opposed region in which the head is opposed to the support face, to a cleaning
a maintenance unit configured to perform maintenance to the head, wherein
the maintenance unit is disposed further toward one direction of the first direction than the medium support portion,
the standby position is disposed further toward one direction of the first direction than the medium support portion, and
when a movement instruction is inputted into the input unit, the control unit causes the head to move to be opposed to the maintenance unit during movement of the head from the standby position to the cleaning position.

5. The printing apparatus according to claim 4 further comprising:
a maintenance cover; and
a cover driving unit, wherein
the maintenance cover is configured to move to an open position at which the maintenance unit is opened and also to a close position at which the maintenance unit is closed,
the cover driving unit causes the maintenance cover to move, and
when a movement instruction is inputted into the input unit, the control unit controls the cover driving unit to move the maintenance cover to the open position.

6. The printing apparatus according to claim 1, further comprising:
an interference detector configured to detect interference against the head, wherein
the interference detector operates in association with movement of the head in the second direction, and
position, a portion of or whole of the cleaning position being included in the opposed region.
